(19) United States
(12) Patent Application Publication
(10) Pub. No.: US 2006/0294563 A1
(43) Pub. Date: Dec. 28, 2006

(54) Healthcare set-top-box monitoring system

(75) Inventor: Fabien Marcel Jacques Guillorit, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 10/572,833

(22) PCT Filed: Sep. 21, 2004
(86) PCT No.: PCT/IB04/51816

§ 371 Date: Mar. 21, 2006

Related U.S. Application Data
(60) Provisional application No. 60/504,998, filed on Sep. 22, 2003.

(51) Int. Cl. H04N 7/173

(52) U.S. Cl. 725/108; 725/100; 725/131; 725/105

(57) ABSTRACT

A method for healthcare monitoring of a person is provided. The method including: operatively connecting a set-top-box (102) to a network (110, 114) and to at least one of a television display (104) and speaker (106); and wirelessly transmitting a healthcare characteristic of the person from one or more wireless sensors (108) to the set-top-box (108). The remote network can be the Internet (110). The method can further include operatively connecting the set-top-box (110) to a remote station (124) through the network (110). The remote station (124) can be a location of a medical professional.

The present invention relates generally to healthcare monitoring, and more particularly, to a personal system for monitoring healthcare through a set-top-box.

Some people, such as the elderly require supervision at home. Typically, a medical (or health care) professional, such as a nurse, monitors the person's well being at the home of the person. However, such monitoring by a health care professional is very expensive. Furthermore, in some situations, while a monitoring is required, full-time monitoring by a health care professional is not necessary.

There are systems known in the art that utilize a computer, such as a personal computer for monitoring the healthcare of a person. However, such systems are not very useful because the computer is not always on, is not always located in a convenient place in the person's home, and requires a relatively complicated input through various input devices such as a keyboard or mouse.

Therefore it is an object of the present invention to provide a healthcare monitoring system that overcomes the disadvantages associated with the prior art healthcare monitoring systems.

Accordingly, a system for healthcare monitoring of a person is provided. The system comprising: a set-top-box operatively connected to at least one of a television display and speaker, the set-top-box being further operatively connected to a network; and one or more wireless sensors for measuring a healthcare characteristic of the person and transmitting the same to the set-top-box, the one or more wireless sensors being wirelessly connected to the set-top-box.

The system can further comprise a remote station operatively connected to the set-top-box through the network, wherein the healthcare characteristic is transmitted from the set-top-box to the remote station via the network. The remote station can be a location of a medical professional. In which case the system can further comprise at least one medical equipment having at least one function under the control of the set-top-box via the remote station.

The set-top-box can have means for contacting a medical professional other than through the network. In which case, the system can further comprise a remote station operatively connected to the set-top-box through the network, wherein an instruction for contacting the medical professional originates at the remote station.

The set-top-box can have means for alerting the person on one of the television display and speaker of at least one of a type of medication to take, a dose of medication to take, and a description of medication to take.

Where the system further comprises a remote station operatively connected to the set-top-box through the network, the system can further comprise at least one video camera operatively connected to the set-top-box for transmitting a video signal of the person to the remote station.

Where the remote station is a location of a medical professional, the system can further comprise at least one video camera operatively connected to the location of the medical professional for transmitting a video signal of the medical professional to the set-top-box for display on the television display.

Also provided is a method for healthcare monitoring of a person. The method comprising: operatively connecting a set-top-box to a network and to at least one of a television display and speaker; and wirelessly transmitting a healthcare characteristic of the person from one or more wireless sensors to the set-top-box. The operatively connecting can comprise connecting the set-top-box to the Internet.

The method can further comprise operatively connecting the set-top-box to a remote station through the network, wherein the healthcare characteristic is transmitted from the set-top-box to the remote station via the network. The operatively connecting of the set-top-box to the remote station can comprise connecting the set-top-box to a medical professional. The method can further comprise controlling at least one function of a medical equipment from the set-top-box via the remote station.

The method can further comprise contacting a medical professional from the set-top-box other than through the network. The remote station can be operatively connected to the set-top-box through the network and the contacting can comprise issuing an instruction for contacting the medical professional from the remote station.

The method can further comprise alerting the person on one of the television display and speaker from the set-top-box of at least one of a type of medication to take, a dose of medication to take, and a description of medication to take.

Where the system further comprises a remote station operatively connected to the set-top-box through the network, the method can further comprise transmitting a video signal of the person from the set-top-box to the remote station.

Where the remote station is a location of a medical professional, the method can further comprise transmitting a video signal of the medical professional from the remote station to the set-top-box and displaying the video content on the television display.

The method can further comprise wirelessly transmitting the healthcare characteristic to an ambulance over a wireless network.

The method can further comprise: storing a period of the healthcare characteristic in a memory in the set-top-box; and retrieving at least a portion of the stored healthcare characteristic from the memory for diagnosis of the person.

These and other features, aspects, and advantages of the apparatus and methods of the present invention will become better understood with regard to the following description, appended claims, and accompanying drawings where:

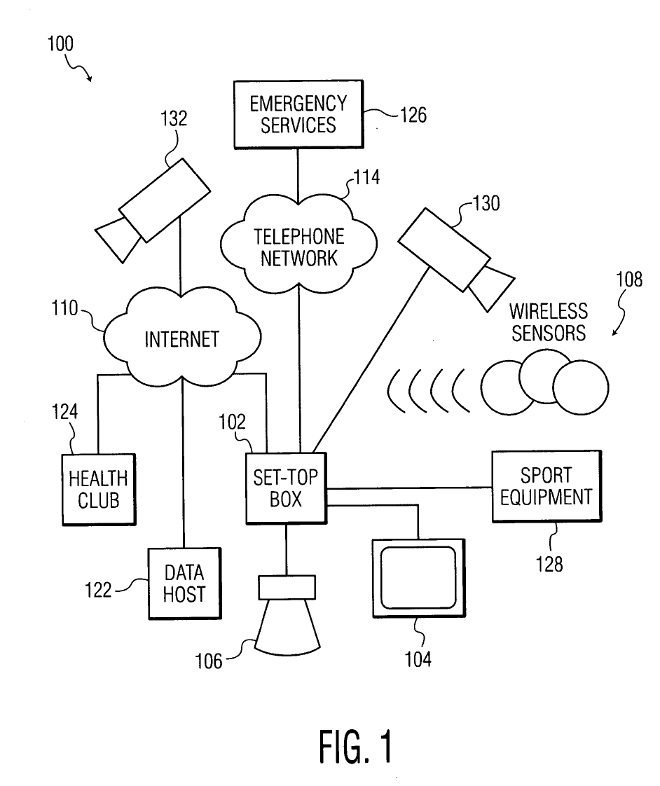

FIG. 1 illustrates a schematic illustration of an embodiment of a system for healthcare monitoring.

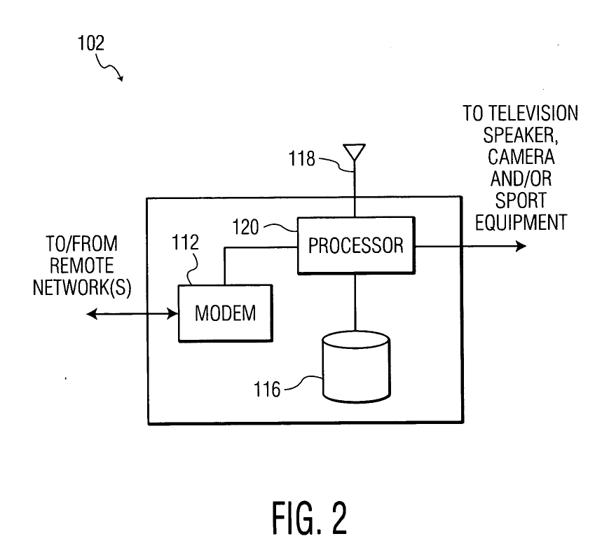

FIG. 2 illustrates a schematic illustration of a set-top-box for use with the system of FIG. 1.

Referring now to FIG. 1, there is shown a system for healthcare monitoring of a person, the system being generally referred to by reference numeral 100.

The system 100 includes a set-top-box 102 operatively connected to at least one of a television display 104 and a speaker 106. The system 100 preferably includes both the television display 104 and speaker(s) 106. Furthermore, the speaker(s) 106 can be integral with the television display 104 or separate therefrom, such as a surround sound/home theater system. The set-top-box 102, besides the functions described below can also be used for other functions associated with a television, such as a cable tuner or personal video recorder (PVR).

The system also includes one or more wireless sensors 108 for measuring a healthcare characteristic of the person and wirelessly transmitting the same to the set-top-box. The one or more wireless sensors are wirelessly connected to the set-top-box 102. The healthcare characteristic can be any health related characteristic, such as the person's vital signs, heart monitoring, or blood sugar level. The wireless sensors 108 can communicate with the set-top-box 102 through any wireless medium, such as RF or infrared, and by any wireless protocol, such as Bluetooth, RFID, or Zigbee. The wireless sensors 108 can be lightweight and wearable by the person or heavy standalone equipment.

Referring now also to FIG. 2, the set-top-box 12 is illustrated therein in more detail. The set-top-box 104 is further operatively connected to a network, such as the Internet 110 through a modem 112. However, other remote networks are also possible, such as plain old telephony (POTS) 114, cellular, and satellite. Although a single modem 112 is shown in FIG. 2, those skilled in the art will appreciate that more than one modem may be used, each of which is dedicated to accessing a different network. For example, a cable modem may be used to access the Internet 110 and a dial-up modem may be used to access the telephone network 114. The Internet 110 may be used to access a data host 122 or a remote station 124, such as a medical professional, including a doctor, hospital, nurse, dentist, and the like. The telephone network 114 may also be used to access such medical professionals and may further be used to contact emergency services 126, such as a paramedic or ambulance service. The telephone network 114 may also be used to contact ambulance personnel using a cellular link while on route to the person. The ambulance personnel could look at the person's vital signs or other healthcare characteristics before arriving at the person and could prepare accordingly.

The set-top-box 102 also includes a storage device 116, such as a hard drive for storing program instructions for carrying out the methods of the present invention as well as other functions of the set-top-box 102. The storage device 116 can also be used to store video content and/or a user profile. Although the storage device 116 is shown as a single device, those skilled in the art will appreciate that it can be multiple storage devices, each dedicated to storing different types of data. The set-top-box 102 further includes a transmitter/receiver, shown schematically by antenna 118. The antenna 118 receives the wireless signals from the wireless sensors 108 which are processed, formatted, and/or transformed, if necessary, into a useful signal by a processor 120. The processor 120 also controls the modem 112, storage device 116, television display 104, and speaker 106 as is known in the art. The antenna 118 may also transmit a signal to other equipment for the control of such other equipment as will be discussed below. The antenna 118 may be dedicated for use with the wireless sensors 108 or may be used in combination with other functions of the set-top-box 102, such as to receive wireless signals from a remote control (not shown) for use with the set-top-box 102. The remote control can be used to control the set-top-box 102 and may also be used to input information into the set-top-box 102 through an appropriate user interface as is known in the art.

Referring back to FIG. 1, the system 100 can further include medical equipment 128 for controlling the medical equipment from the remote station 124, e.g., by a doctor, via the set-top-box 102. Thus, the medical equipment(s) 128 has at least one function under the control of the set-top-box 102 via the remote station 124. Examples of such medical equipment 128 are heart monitoring systems, blood pressure machines, a brain monitor, and an artificial breathing system (oxygen tank status).

The system 100 may also be supplied with one or more video cameras 130 positioned at the location of the set-top-box 102 and operatively connected to the processor 120. The camera 130 is useful in capturing image or video of the person being monitored. The camera 130 may be supplied in more than one room of the person's home and may have pan-tilt-zoom capabilities in order to follow the person as he/she moves about the room. The camera 130 may be under the control of a recognition system that can recognize and track the person and control the pan-tilt-zoom motors of the camera accordingly to maintain the person in the field of view of the camera 130. Such recognition systems are well known in the art. The system 100 may also have one or more cameras 132 at the remote station for capturing image or video of an individual, such as a medical professional, at the remote station. The camera 132 at the remote station 124 may have the pan-tilt-zoom and recognition capabilities as previously described above with regard to camera 130.

A method for healthcare monitoring of a person will now be described with reference to FIGS. 1 and 2. As discussed above, the set-top-box 102 is operatively connected to a network, such as the Internet 110, and a remote station 124, such as a medical professional, via the modem 112. The set-top-box 102 is also operatively connected to at least one of, and preferably both of, the television display 104 and speaker 106 via the processor 120. The set-top-box 102 is further wirelessly connected to the sensors 108 via the antenna 118 and processor 120. The sensor(s) 108 detect a healthcare characteristic of the person and transmits a signal corresponding to the healthcare characteristic to the set-top-box. The healthcare characteristic is transmitted from the set-top-box 102 to the remote station 124 via the network 110 where it can be accessed by individuals at the remote station 124, such as a doctor. The healthcare characteristics can be accessed in real-time, thus, permitting quick and timely decisions to be made in the best interests of the person being monitored. The doctor would typically access the healthcare characteristic information, such as the person's vital signs, on a display screen. The display screen is preferably part of a computer (not shown) that is operatively connected to the network 110. A history of the healthcare characteristics can be stored at the storage device 116 and accessed (e.g., printed) by a doctor or other healthcare professional when they visit the person or brought to the person's doctor when the person visits the doctor or another doctor.

As also discussed above, the medical professional at the remote station 124 can instruct the set-top-box 102 to contact another medical professional, such as emergency services 126, through another network, such as through the telephone network 114. Thus, if the doctor is concerned that a dangerous situation is imminent based on the detected healthcare characteristics, he or she may instruct the set-top-box 102 to contact an ambulance. The contact information for the ambulance is previously stored in the storage device 116 through an appropriate user interface. The system 100 can also alert the person on one of the television display 104 or speaker 106 from the set-top-box 102 of at least one of a type of medication to take, a dose of medication to take, and/or a description of medication to take. For example, the set-top-box can instruct the television display 104 to display a picture of the medication taken by the person to remind the person to take the medicine. The set-top-box can also instruct the television display 104 to display an indication on how many of such medicine to take. The indication can also be reproduced on the speaker 106. The alerting of the person of the type of medication to take, dose of medication to take, and/or description of medication to take may be initiated by an individual at the remote station 124 (e.g., from a doctor based on the monitored vital signs of the person) or programmed into the set-top-box through an appropriate user interface as a daily reminder.

The system 100 may also be used to provide a videoconference between an individual at the remote station (e.g., a doctor) and the person being monitored using the cameras 130, 132. Therefore, a video signal of the person from camera 130 can be transmitted from the set-top-box 102 to the remote station via the network 110 and displayed at a display device (not shown) at the remote station 124. Similarly, a video signal of the medical professional from camera 132 can be transmitted from the remote station 110 to the set-top-box 102 and displayed on the television display 104. In this manner, the medical professional and the person being monitored can conduct a videoconference.

The medical professional can also control at least one function of the medical equipment 128 from the set-top-box 102 via the remote station 124 based on the detected healthcare characteristics. For example, where the medical equipment 128 is an artificial breathing system, a doctor at the remote station 124 can control the rate of oxygen to the person in response to the detected healthcare characteristics.

The system 100 can also be used to store a period of the healthcare characteristics transmitted from the sensors 108. For example, the set-top-box can store the previous hour of transmitted healthcare characteristics in a first-in-first-out basis. The length of the period can be programmable through a remote control via an appropriate user interface displayed on the television display 104. The stored healthcare characteristics can then be later retrieved by healthcare professionals, such as doctors and paramedics either through the remote network 110, such as through the Internet, through a wireless connection, such as through the telephone network 114, or directly from the set-top-box 102, such as from a connector (not shown) on the set-top-box 102.

Those skilled in the art will appreciate that the system 100 of the present invention offers certain advantages over the computer-based healthcare monitoring systems known in the art. Some of those advantages include:

(a) The set-top-box 102 can remain on standby and can “wake-up” the television display 104 or speakers 106 if the same are off;

(b) Instructions can be input into the set-top-box 102 relatively easy, such as through a remote control and an appropriate user interface; and

(c) If the television display 104 is off, the system 100 can still operate through the speakers 106.

While there has been shown and described what is considered to be preferred embodiments of the invention, it will, of course, be understood that various modifications and changes in form or detail could readily be made without departing from the spirit of the invention. It is therefore intended that the invention be not limited to the exact forms described and illustrated, but should be constructed to cover all modifications that may fall within the scope of the appended claims.

1. A system (100) for healthcare monitoring of a person, the system comprising:
a set-top-box (102) operatively connected to at least one of a television display (104) and speaker (106), the set-top-box (102) being further operatively connected to a network (110, 114); and
one or more wireless sensors (108) for measuring a healthcare characteristic of the person and transmitting the same to the set-top-box (102), the one or more wireless sensors (108) being wirelessly connected to the set-top-box (102).

2. The system of claim 1, wherein the network is the Internet (110).

3. The system of claim 1, further comprising a remote station (124) operatively connected to the set-top-box through the network (110), wherein the healthcare characteristic is transmitted from the set-top-box (102) to the remote station (124) via the network (110).

4. The system of claim 3, wherein the remote station (124) is a location of a medical professional.

5. The system of claim 3, further comprising at least one medical equipment (128) having at least one function under the control of the set-top-box (102) via the remote station (124).

6. The system of claim 1, wherein the set-top-box (102) having means (112) for contacting a medical professional other than through the network (110).

7. The system of claim 6, further comprising a remote station (124) operatively connected to the set-top-box (102) through the network (110), wherein an instruction for contacting the medical professional originates at the remote station (124).

8. The system of claim 1, wherein the set-top-box (102) having means (120) for alerting the person on one of the television display (104) and speaker (106) of at least one of a type of medication to take, a dose of medication to take, and a description of medication to take.

9. The system of claim 3, further comprising at least one video camera (130) operatively connected to the set-top-box (102) for transmitting a video signal of the person to the remote station (124).

10. The system of claim 4, further comprising at least one video camera (132) operatively connected to the location of the medical professional for transmitting a video signal of the medical professional to the set-top-box (102) for display on the television display (104).

11. A method for healthcare monitoring of a person, the method comprising:
operatively connecting a set-top-box (102) to a network and to at least one of a television display (104) and speaker (106); and
wirelessly transmitting a healthcare characteristic of the person from one or more wireless sensors (108) to the set-top-box (102).

12. The method of claim 11, wherein the operatively connecting comprises connecting the set-top-box (102) to the Internet (110).

13. The method of claim 11, further comprising operatively connecting the set-top-box (102) to a remote station (124) through the network (110), wherein the healthcare characteristic is transmitted from the set-top-box (102) to the remote station (124) via the network (110).

14. The method of claim 13, wherein the operatively connecting of the set-top-box (102) to the remote station (124) comprises connecting the set-top-box (102) to a medical professional.

15. The method of claim 13, further comprising controlling at least one function of a medical equipment (128) from the set-top-box (102) via the remote station (124).

16. The method of claim 11, further comprising contacting a medical professional from the set-top-box (102) other than through the network (110).

17. The method of claim 16, wherein the remote station (124) is operatively connected to the set-top-box (102) through the network (110), wherein the contacting comprises issuing an instruction for contacting the medical professional from the remote station (124).

18. The method of claim 11, further comprising alerting the person on one of the television display (104) and speaker (106) from the set-top-box (102) of at least one of a type of medication to take, a dose of medication to take, and a description of medication to take.

19. The method of claim 13, further comprising transmitting a video signal of the person from the set-top-box (102) to the remote station (124).

20. The method of claim 14, further comprising transmitting a video signal of the medical professional from the remote station (124) to the set-top-box (102) and displaying the video signal on the television display (104).

21. The method of claim 11, further comprising wirelessly transmitting the healthcare characteristic to an ambulance over a wireless network (114).

22. The method of claim 11, further comprising:
storing a period of the healthcare characteristic in a memory (116) in the set-top-box (102); and
retrieving at least a portion of the stored healthcare characteristic from the memory (116) for diagnosis of the person.
